(19) United States
(12) Patent Application Publication
(10) Pub. No.: US 2018/0129537 A1
(43) Pub. Date: May 10, 2018

(54) MANAGING MEMORY USAGE USING SOFT MEMORY TARGETS

(71) Applicant: Microsoft Technology Licensing, LLC, Redmond, WA (US)

(72) Inventors: Timothy Kurtzman, Redmond, WA (US); Jeremy Payne Robinson, Seattle, WA (US); Andrew Whitechapel, Seattle, WA (US)

(73) Assignee: Microsoft Technology Licensing, LLC, Redmond, WA (US)

(21) Appl. No.: 15/348,744

(22) Filed: Nov. 10, 2016

(51) Int. Cl. G06F 9/50

(52) U.S. Cl. CPC G06F 9/5016; G06F 9/5083

(57) ABSTRACT

An example system for managing memory usage includes memory and a processor configured to publish a soft memory target for each of a plurality of applications, wherein the soft memory target is to be statically predetermined based at least on a detected state of execution of each application and a size of the memory of the system. The processor is to also detect that an application exceeds the soft memory target. Additionally, the processor is to detect that a total memory usage of the system exceeds a threshold amount. The processor is to further terminate the application based at least in part on the detected soft memory target being exceeded and in response to detecting that the total memory usage of the system exceeds the threshold amount.

### BACKGROUND

Applications on resource-constrained devices may share a limited amount of memory. In order to deliver consistent and predictable experiences to the user, applications may thus adjust their memory usage to fit in well and cooperate with other applications running in the system.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

An embodiment described herein includes a system for managing memory usage. The system includes memory and a processor configured to publish a soft memory target for each of a plurality of applications. The soft memory target can be statically predetermined based at least on a detected state of execution of each application and a size of the memory of the system. The processor can also detect that an application exceeds the soft memory target. Additionally, the processor can also detect that a total memory usage of the system exceeds a threshold amount. The processor can then terminate the application based at least in part on the detected soft memory target being exceeded and in response to detecting that the total memory usage of the system exceeds the threshold amount.

Another embodiment described herein includes a method for managing memory usage. The method can include publishing soft memory targets for a plurality of applications. The soft memory targets can be statically predetermined based at least on states of execution of the plurality of applications and a total available system memory. The method can also include generating a termination priority list for the plurality of applications based on a termination score for each application. The termination score for each application can be calculated based at least on the detected state of execution of each application and whether the soft memory target for each application is exceeded. The method can further include terminating an application with the termination score that exceeds the termination score of other applications in the termination priority list in response to detecting that a memory usage of the total available system memory exceeds a threshold amount.

Another embodiment described herein includes another system for managing memory use. The system can include a memory and processor configured to statically predetermine soft memory targets based on execution states and a total memory size of the system. The processor can also be configured to publish the soft memory targets to the applications. The processor can further be configured to assign the applications termination scores based on application memory usage. The processor can also be configured to detect an application exceeds a soft memory target. The processor can also further be configured to increase the termination score of the application in response to detecting the application exceeds of the soft memory target. The processor can also be configured to detect that a total memory usage of the system exceeds a threshold amount. The processor can be configured to terminate an application with a higher termination score than other applications.

Another embodiment described herein includes another method for managing memory use. The method can include statically predetermining soft memory targets based on execution states and a total memory size of a system. The method can also include publishing the soft memory targets to the applications. The method can further include assigning the applications termination scores based on application memory usage. The method can also include detecting an application exceeds a soft memory target. The method can further include increasing the termination score of the application in response to detecting the exceeding of the soft memory target. The method can also further include detecting that a total memory usage of a device exceeds a threshold amount. The method can include terminating an application with a higher termination score than other applications.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is a block diagram of an example of a computing system that can manage memory usage using soft memory targets;

FIG. 2 is a detailed process flow diagram of an example process for managing memory usage using soft memory targets;

FIG. 3 is a process flow diagram of another example method for managing memory usage using soft memory targets;

FIG. 4 is a process flow diagram of another example method for managing memory usage using soft memory targets; and

FIG. 5 is a block diagram of an example computer-readable storage media that can manage memory usage using soft memory targets.

### DETAILED DESCRIPTION

In some examples, an operating system may allow applications to run without any memory caps, but the applications can be terminated at any time. A memory cap, as used herein, refers to a preset amount of memory that is allocated to each application. For example, an application that exceeds a hard memory cap may be terminated. For example, an application may be terminated when system memory usage exceeds a threshold. In some examples, an operating system may place hard memory caps on processes. For example, based on a state of the process, a hard memory cap may be published that an application must stay under. If an application tries to allocate more memory than a relevant hard memory cap, then the allocation may fail and may result in the application crashing or terminating.

However, some application features may use more memory for shorter periods of time. While memory caps may prevent a device from entering an out of memory state, there are applications that may not always fit under these memory constraints. For example, in more sophisticated Voice over Internet Protocol (VoIP) scenarios, an app may not be executed with less than a predetermined amount of memory. In another example, when running an app including Turn By Turn directions, there may be a momentary spike in the application's memory usage while new maps are downloaded. If the device is not attempting to run these tasks simultaneously, then the system may be able to support the extra memory usage of the tasks that are trying to run.

In embodiments described herein, a system can manage memory usage using soft memory targets. A soft memory target, as referred to herein, can include a statically predetermined amount of memory that can be used by an application in a particular execution state. For example, the soft memory target for a foreground app may be larger than the soft memory target for the same app running in the background. The system described herein can publish soft memory targets for a plurality of applications, wherein the soft memory targets are to be statically predetermined based at least on a detected state of execution of each application and a size of the memory of the system. For example, the system can provide each application a set of soft memory targets for a set of execution states. The system can then detect that an application exceeds the soft memory target. In some embodiments, the system can send the application a notification indicating the soft memory target is exceeded in response to detecting that the application exceeds the soft memory target. The system can also detect that a total memory usage of the system exceeds a threshold amount. The system may then terminate the application based at least in part on the detected soft memory target being exceeded and in response to detecting that the total memory usage of the system exceeds the threshold amount. For example, the processor may terminate the application based on a termination score. The termination score can be based on memory usage of the application and the detected soft memory target being exceeded. For example, an app that exceeds a relevant soft memory target may have a higher termination score and thus have a higher likelihood of being terminated when total system memory use exceeds a threshold amount. Otherwise, the processor may allow the application to continue running with the soft memory target exceeded in response to detecting that the total memory usage of the system does not exceed the threshold amount.

In some embodiments, the application can reduce application memory usage in response to receiving a notification indicating that the soft memory target is exceeded. For example, the application may reduce application memory usage to below the soft memory target to reduce its termination score and thus the likelihood of being terminated. Thus, the present techniques enable more flexible memory use and allow applications to operate between the options of increased memory availability and increased likelihood of termination. In some examples, the same application may be able to deliver additional features on devices with larger memory while also being able to operate more efficiently on devices with less memory resources.

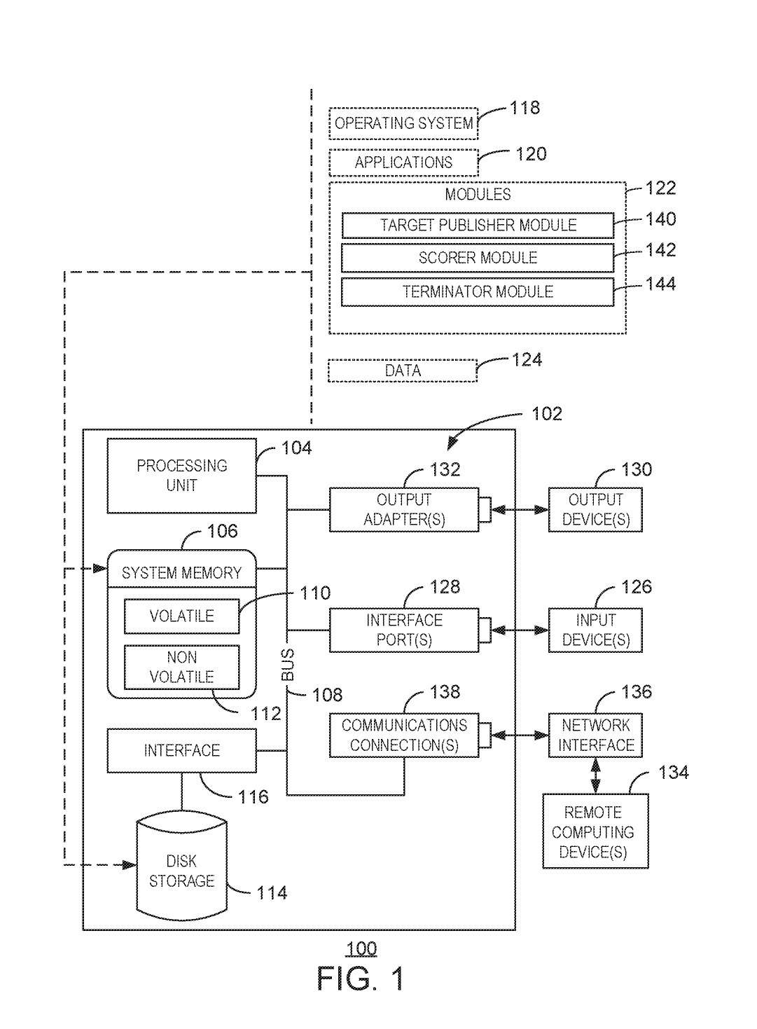

As a preliminary matter, some of the figures describe concepts in the context of one or more structural components, referred to as functionalities, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1 discussed below, provide details regarding different systems that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computer systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable device, or media.

Computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not storage media) may additionally include communication media such as transmission media for wireless signals and the like.

FIG. 1 is a block diagram of an example of a computing system that can manage memory usage using soft memory targets. The example system 100 includes a computing device 102. The computing device 102 includes a processing unit 104, a system memory 106, and a system bus 108. In some examples, the computing device 102 can be a gaming console, a personal computer (PC), an accessory console, a gaming controller, among other computing devices. In some examples, the computing device 102 can be a node in a cloud network.

The system bus 108 couples system components including, but not limited to, the system memory 106 to the processing unit 104. The processing unit 104 can be any of various available processors. Dual microprocessors and other multiprocessor architectures also can be employed as the processing unit 104.

The system bus 108 can be any of several types of bus structure, including the memory bus or memory controller, a peripheral bus or external bus, and a local bus using any variety of available bus architectures known to those of ordinary skill in the art. The system memory 106 includes computer-readable storage media that includes volatile memory 110 and nonvolatile memory 112.

The basic input/output system (BIOS), containing the basic routines to transfer information between elements within the computer 102, such as during start-up, is stored in nonvolatile memory 112. By way of illustration, and not limitation, nonvolatile memory 112 can include read-only memory (ROM), programmable ROM (PROM), electrically programmable ROM (EPROM), electrically erasable programmable ROM (EEPROM), or flash memory.

Volatile memory 110 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 102 also includes other computer-readable media, such as removable/non-removable, volatile/non-volatile computer storage media. FIG. 1 shows, for example a disk storage 114. Disk storage 114 includes, but is not limited to, devices like a magnetic disk drive, floppy disk drive, tape drive, Jaz drive, Zip drive, LS-210 drive, flash memory card, or memory stick.

In addition, disk storage 114 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 114 to the system bus 108, a removable or non-removable interface is typically used such as interface 116.

It is to be appreciated that FIG. 1 describes software that acts as an intermediary between users and the basic computer resources described in the suitable operating environment 100. Such software includes an operating system 118. Operating system 118, which can be stored on disk storage 114, acts to control and allocate resources of the computer 102.

System applications 120 take advantage of the management of resources by operating system 118 through program modules 122 and program data 124 stored either in system memory 106 or on disk storage 114. It is to be appreciated that the disclosed subject matter can be implemented with various operating systems or combinations of operating systems.

A user enters commands or information into the computer 102 through input devices 126. Input devices 126 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, and the like. In some examples, an input device can include Natural User Interface (NUI) devices. NUI refers to any interface technology that enables a user to interact with a device in a “natural” manner, free from artificial constraints imposed by input devices such as mice, keyboards, remote controls, and the like. In some examples, NUI devices include devices relying on speech recognition, touch and stylus recognition, gesture recognition both on screen and adjacent to the screen, air gestures, head and eye tracking, voice and speech, vision, touch, gestures, and machine intelligence. For example, NUI devices can include touch sensitive displays, voice and speech recognition, intention and goal understanding, and motion gesture detection using depth cameras such as stereoscopic camera systems, infrared camera systems, RGB camera systems and combinations of these. NUI devices can also include motion gesture detection using accelerometers or gyroscopes, facial recognition, three-dimensional (3D) displays, head, eye, and gaze tracking, immersive augmented reality and virtual reality systems, all of which provide a more natural interface. NUI devices can also include technologies for sensing brain activity using electric field sensing electrodes. For example, a NUI device may use Electroencephalography (EEG) and related methods to detect electrical activity of the brain. The input devices 126 connect to the processing unit 104 through the system bus 108 via interface ports 128. Interface ports 128 include, for example, a serial port, a parallel port, a game port, and a universal serial bus (USB).

Output devices 130 use some of the same type of ports as input devices 126. Thus, for example, a USB port may be used to provide input to the computer 102 and to output information from computer 102 to an output device 130.

Output adapter 132 is provided to illustrate that there are some output devices 130 like monitors, speakers, and printers, among other output devices 130, which are accessible via adapters. The output adapters 132 include, by way of illustration and not limitation, video and sound cards that provide a means of connection between the output device 130 and the system bus 108. It can be noted that other devices and systems of devices provide both input and output capabilities such as remote computing devices 134.

The computer 102 can be a server hosting various software applications in a networked environment using logical connections to one or more remote computers, such as remote computing devices 134. The remote computing devices 134 may be client systems configured with web browsers, PC applications, mobile phone applications, and the like. The remote computing devices 134 can be a personal computer, a server, a router, a network PC, a workstation, a microprocessor based appliance, a mobile phone, a peer device or other common network node and the like, and typically includes many or all of the elements described relative to the computer 102.

Remote computing devices 134 can be logically connected to the computer 102 through a network interface 136 and then connected via a communication connection 138, which may be wireless. Network interface 136 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 138 refers to the hardware/software employed to connect the network interface 136 to the bus 108. While communication connection 138 is shown for illustrative clarity inside computer 102, it can also be external to the computer 102. The hardware/software for connection to the network interface 136 may include, for exemplary purposes, internal and external technologies such as, mobile phone switches, modems including regular telephone grade modems, cable modems and DSL modems, ISDN adapters, and Ethernet cards.

The computer 102 includes one or more modules 122, such as a target publisher module 140, a scorer module 142, and a terminator module 144. In some embodiments, the target publisher module 140 can publish soft memory targets for a plurality of applications. In some examples, the scorer module 142 can statically predetermine the soft memory targets based at least on a detected state of execution of each application and a size of the volatile memory 110. For example, the soft memory targets can be statically predetermined based on historical data regarding the amount of memory actually used by a representative range of applications in a given state or of a particular type. In some examples, the soft memory targets can be statically predetermined based on a device type. In some examples, the soft memory targets can be statically predetermined based on a device memory configuration. The scorer module 142 can detect that an application exceeds the soft memory target. In some embodiments, the scorer module 142 can assign the applications termination scores based on an execution state of each application. In some examples, the scorer module 142 can adjust the termination scores of the applications based on memory usage of each application. In some embodiments, the scorer module 142 can send the application a notification indicating the soft memory target is exceeded in response to detecting that the application exceeds the soft memory target. In some examples, the application may reduce application memory usage in response to receiving a notification indicating that the soft memory target is exceeded. In some embodiments, the scorer module 142 can increase the termination score of the application in response to detected exceeding of the soft memory target.

The terminator module 144 can detect that a total memory usage of the system exceeds a threshold amount. The terminator module 144 can terminate the application based at least in part on the detected soft memory target being exceeded and in response to detecting that the total memory usage of the system exceeds the threshold amount. For example, the terminator module 144 can terminate the application based on a termination score. The termination score can be based on application memory usage and the detected soft memory target being exceeded. For example, the terminator module 144 can terminate an application with a higher termination score than other applications. In some examples, the terminator module 144 can otherwise allow the application to continue running with the soft memory target exceeded in response to detecting that the total memory usage of the system does not exceed the threshold amount.

It is to be understood that the block diagram of FIG. 1 is not intended to indicate that the computing system 102 is to include all of the components shown in FIG. 1. Rather, the computing system 102 can include fewer or additional components not illustrated in FIG. 1 (e.g., additional applications, additional modules, additional memory devices, additional network interfaces, etc.). Furthermore, any of the functionalities of the target publisher module 140, scorer module 142, and terminator module 144, may be partially, or entirely, implemented in hardware and/or in the processor 104. For example, the functionality may be implemented with an application specific integrated circuit, in logic implemented in the processor 104, or in any other device.

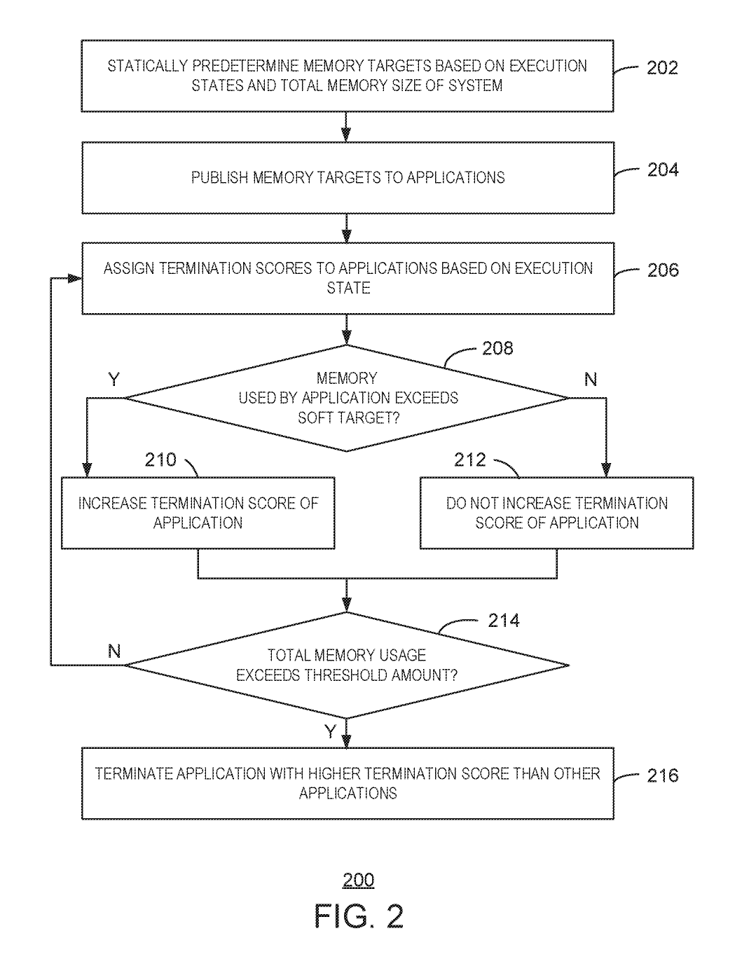

FIG. 2 is a process flow diagram of an example method for managing memory usage using soft memory targets. The method 200 can be implemented with any suitable computing device, such as the computing system 102 of FIG. 1.

At block 202, the processor statically predetermines soft memory targets based on execution states and a total memory size of a system. For example, the execution states may include a foreground execution state, a background execution state, a frozen state, a prelaunched state, among other possible states. For example, a prelaunched state may be a state where an application is technically running in the background but not performing any tasks. In some examples, the processor may assign larger soft memory targets for foreground execution states than background execution states. In some examples, the processor may predetermine soft memory targets based on additional factors, such as historical data regarding the amount of memory actually used by a representative range of applications in a given state or of a particular type, a device type, a device memory configuration, or any combination thereof. In some examples, historical data can be collected locally on a specific device, and can include a user's specific usage of the device. For example, a foreground app may receive a high soft memory target while showing a user interface (UI), whereas a background task without any UI display may receive a lower soft memory target. In another example, an application running on a phone may receive a different soft memory target from the same application running on a desktop PC, and a different soft memory target again on a gaming system, or other devices. Device memory configurations can include, for example, a 1 GB device, a 2 GB device, a 4 GB device, etc.

At block 204, the processor publishes the soft memory targets to the applications. For example, the processor may provide the applications callbacks to be used to determine an amount of memory and whether a soft target has been exceeded. In some examples, the processor can update the soft memory target for the application based on a detected change in a state of execution of the application.

At block 206, the processor assigns the applications termination scores based on execution state. In some examples, the processor may then adjust the termination score for the applications based on memory usage. The termination scores can be used to determine priority of application for purposes of termination. For example, applications with higher memory usage may receive higher termination scores. In some examples, the termination scores may be priority levels. For example, a foreground application that is displaying a UI and with which the user is interacting can be assigned a higher priority level. When the user switches to another app, the first app may continue to execute but now be assigned a Medium priority level. In some examples, if the user minimizes the application, then the priority can drop lower. In another example, a background task that is triggered when a timer event expires and does not display any UI may have an even lower priority. In some examples, the processor can adjust the termination score of the application based on changes in memory usage. For example, an application may reduce its memory usage to lower its termination score and reduce the likelihood of being terminated.

At decision diamond 208, the processor determines whether memory used by an application exceeds a soft memory target. For example, the processor may compare the amount of memory used by the application with an assigned soft memory target for the application. If the processor detects that the amount of memory used by the application exceeds the soft memory target, then the method may continue at block 210. If the processor detects that the amount of memory used by the application does not exceed the soft memory target, then the method may continue at block 212.

At block 210, the processor increases the termination score of the application. For example, an application may exceed a soft memory target for a period of time in order to execute a memory-intensive process. The application may then have an increased termination score and thus an increased likelihood of being terminated if total system memory usage exceeds a threshold level. In some examples, the application may then be placed higher in a list for termination and thus have a higher likelihood of being terminated.

At block 212, the processor does not increase the termination score of the application. For example, the application may remain in the same priority in a list for termination and thus have the same likelihood of being terminated.

At decision diamond 214, the processor determines whether total memory usage of the system exceeds a threshold amount. For example, the threshold amount may be predefined as a percentage of total system memory or a predetermined amount of total system memory. If the processor detects that the total memory usage of the system exceeds the threshold amount, then the method may continue at block 216. If the processor detects that the total memory usage of the system does not exceed the threshold amount then the method may continue at block 206.

At block 216, the processor terminates an application with a higher termination score than other applications. For example, an application that is exceeding its soft memory target may have a higher termination score than other applications and thus be selected for termination accordingly. In some examples, applications at the top of a list ranked by termination score can be terminated one at a time until system memory usage is below a threshold amount.

In one embodiment, the process flow diagram of FIG. 2 is intended to indicate that the steps of the method 200 are to be executed in a particular order. Alternatively, in other embodiments, the steps of the method 200 can be executed in any suitable order and any suitable number of the steps of the method 200 can be included. Further, any number of additional steps may be included within the method 200, depending on the specific application. For example, the soft memory targets can be changed based on changes in execution state or available system memory. In some examples, the applications and in-process frameworks can monitor notifications from the processor to determine whether to free memory based on memory usage of the application in relation to the updated soft memory target. In some examples, if the system wants to run new applications, and launching that application will cause the total memory usage to exceed that threshold amount, then the system can compare the termination score of the yet-to-be-launched application, and see if yet-to-be-launched application is more important than a currently running application, and if so, the system can perform one or more terminations of currently running applications.

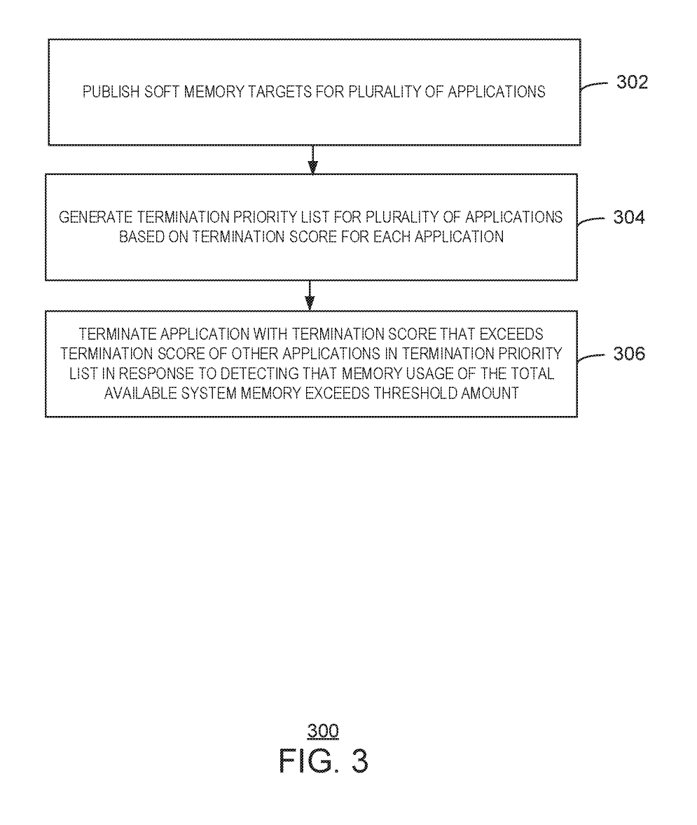

FIG. 3 is a process flow diagram illustrating an example method for managing memory usage using soft memory targets. The method 300 can be implemented with any suitable computing device, such as the computing system 102 of FIG. 1.

At block 302, the processor publishes soft memory targets for a plurality of applications. For example, the soft memory targets are to be statically predetermined based at least on states of execution of the plurality of applications and a total available system memory. In some examples, the processor can update the soft memory target for the application based on detected change in a state of execution of the application. For example, the application may have changed from a foreground state to a background state, or from a background state to a foreground state with a UI.

At block 304, the processor generates a termination priority list for the plurality of applications based on a termination score for each application. For example, the termination score for each application is calculated based at least on the detected state of execution of the application and whether the soft memory target is exceeded. In some examples, the processor can adjust the termination score of the application based on a change in memory usage of the application. In some examples, termination scores can be implemented as statically predefined priority levels. For example, foreground applications may receive higher priority than minimized applications. Similarly, minimized applications may receive higher priority than background applications.

At block 306, the processor terminates an application with a termination score that exceeds the termination score of other applications in the termination priority list in response to detecting that a memory usage of the total available system memory exceeds a threshold amount. For example, the processor may terminate an application that is higher than other applications in the termination priority list in response to detecting that a memory usage of the total available system memory exceeds the threshold amount. For example, a system may have other applications and processes running and thus may free additional memory for these applications and processes when total system memory usage exceeds a threshold amount. In this way, applications having higher priority and thus lower in the termination priority list may continue to run unaffected by the limited memory of the system.

In one embodiment, the process flow diagram of FIG. 3 is intended to indicate that the steps of the method 300 are to be executed in a particular order. Alternatively, in other embodiments, the steps of the method 300 can be executed in any suitable order and any suitable number of the steps of the method 300 can be included. Further, any number of additional steps may be included within the method 300, depending on the specific application. For example, the processor can also send a notification to an application in response to detecting that the soft target for the application is exceeded. The application can then adjust its memory usage accordingly to reduce likelihood of termination. In some examples, the processor may provide the application with a callback to be used to determine an amount of memory to release based on the soft memory target. In some examples, the process may also send the application a notification in response to detecting that the soft target is no longer exceeded.

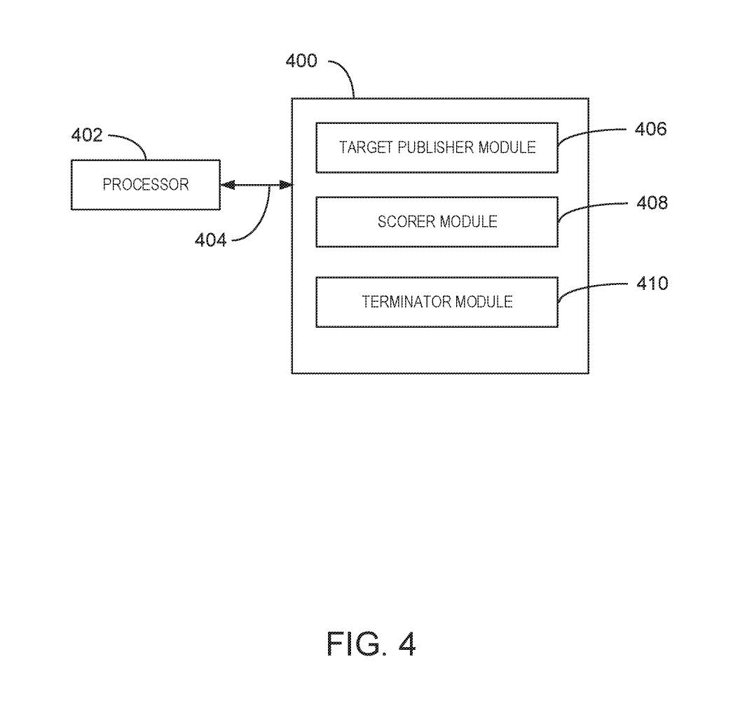

FIG. 4 is a block diagram of an example computer-readable storage media that can manage memory usage using soft memory targets. The tangible, computer-readable storage media 400 may be accessed by a processor 402 over a computer bus 404. Furthermore, the tangible, computer-readable storage media 400 may include code to direct the processor 402 to perform the steps of the current methods.

The various software components discussed herein may be stored on the tangible, computer-readable storage media 400, as indicated in FIG. 4. For example, the tangible computer-readable storage media 400 can include a target publisher module 406, a scorer module 408, and a terminator module 410. In some embodiments, the target publisher module 406 can publish soft memory targets for a plurality of applications. In some examples, the scorer module 408 can statically predetermine the soft memory targets based at least on a detected state of execution of each application and a size of the memory. For example, the soft memory targets can be statically predetermined based on historical data on the amount of memory actually used by a representative range of applications in a given state or of a particular type. In some examples, the soft memory targets can be statically predetermined based on a device type. In some examples, the soft memory targets can be statically predetermined based on a device memory configuration. The scorer module 408 can detect that an application exceeds the soft memory target. In some embodiments, the scorer module 408 can assign the applications termination scores based on application memory usage. In some embodiments, the scorer module 408 can send the application a notification indicating the soft memory target is exceeded in response to detecting that the application exceeds the soft memory target. In some examples, the application may reduce application memory usage in response to receiving a notification indicating that the soft memory target is exceeded. In some embodiments, the scorer module 408 can increase the termination score of the application in response to detected exceeding of the soft memory target.

The terminator module 410 can detect that a total memory usage of the system exceeds a threshold amount. The terminator module 410 can terminate the application based at least in part on the detected soft memory target being exceeded and in response to detecting that the total memory usage of the system exceeds the threshold amount. For example, the terminator module 410 can terminate the application based on a termination score. The termination score can be based on application memory usage and the detected soft memory target being exceeded. For example, the terminator module 410 can terminate an application with a higher termination score than other applications. In some examples, the terminator module 410 can otherwise allow the application to continue running with the soft memory target exceeded in response to detecting that the total memory usage of the system does not exceed the threshold amount.

It is to be understood that any number of additional software components not shown in FIG. 4 may be included within the tangible, computer-readable storage media 400, depending on the specific application.

### Example 1

This example provides for an example system for presenting search results. The example system includes a memory and a processor configured to publish soft memory targets for a plurality of applications, wherein the soft memory targets are to be statically predetermined based at least on a detected state of execution of each application and a size of the memory of the system. The processor can be configured to detect that an application exceeds the soft memory target. The processor can also be configured to detect that a total memory usage of the system exceeds a threshold amount. The processor can also further be configured to terminate the application based at least in part on the detected soft memory target being exceeded and in response to detecting that the total memory usage of the system exceeds the threshold amount. Alternatively, or in addition, the processor can send the application a notification indicating the soft memory target is exceeded in response to detecting that the application exceeds the soft memory target. Alternatively, or in addition, the processor can terminate the application based on a termination score, wherein the termination score is based on execution state, application memory usage, and the detected soft memory target being exceeded. Alternatively, or in addition, the processor can allow the application to continue running with the soft memory target exceeded in response to detecting that the total memory usage of the system does not exceed the threshold amount. Alternatively, or in addition, the application can reduce application memory usage in response to receiving a notification indicating that the soft memory target is exceeded.

### Example 2

This example provides for a method for managing memory usage. The example method includes publishing soft memory targets for a plurality of applications, wherein the soft memory targets are to be statically predetermined based at least on states of execution of the plurality of applications and a total available system memory. The method also includes generating a termination priority list for the plurality of applications based on a termination score for each application, wherein the termination score for each application is calculated based at least on the detected state of execution of each application and whether the soft memory target for each application is exceeded. The method further also includes terminating an application with the termination score that exceeds the termination score of other applications in the termination priority list in response to detecting that a memory usage of the total available system memory exceeds a threshold amount. Alternatively, or in addition, the method can also include sending a notification to the application in response to detecting that the soft target for the application is exceeded. Alternatively, or in addition, the method can also include updating the soft memory target for the application based on a detected change in a state of execution of the application. Alternatively, or in addition, the method can further include adjusting the termination score of the application based on a change in memory usage of the application. Alternatively, or in addition, the method can include providing the application with a callback to be used to determine an amount of memory to release based on the soft memory target.

### Example 3

This example provides for an example system for presenting search results. The example system includes a memory and a processor configured to statically predetermine soft memory targets based on execution states and a total memory size of the system. The processor can be configured to publish the soft memory targets to the applications. The processor can also further be configured to assign the applications termination scores based on execution state. The processor can also further be configured to detect an application exceeds a soft memory target. The processor can also further be configured to increase the termination score of the application in response to detecting the application exceeds of the soft memory target. The processor can also further be configured to detect that a total memory usage of the system exceeds a threshold amount. The processor can also further be configured to terminate an application with a higher termination score than other applications. Alternatively, or in addition, the processor can send the application a notification indicating that the soft memory target is exceeded. Alternatively, or in addition, the soft memory targets are to be statically predetermined based on historical data on the amount of memory actually used by a representative range of applications in a given state or of a particular type. Alternatively, or in addition, the soft memory targets are to be statically predetermined based on a device type. Alternatively, or in addition, the soft memory targets are to be statically predetermined based on a device memory configuration.

### Example 4

This example provides for a method for managing memory usage. The example method includes statically predetermining soft memory targets based on execution states and a total memory size of a system. The method also includes publishing the soft memory targets to the applications. The method further also includes. The method further also includes assigning the applications termination scores based on execution state. The method further also includes detecting an application exceeds a soft memory target. The method further also includes increasing the termination score of the application in response to detecting the exceeding of the soft memory target. The method further also includes detecting that a total memory usage of a device exceeds a threshold amount. The method further also includes terminating an application with a higher termination score than other applications. Alternatively, or in addition, the method can also include detecting that the application does not exceed the soft memory target and decreasing the termination score of the application in response to detecting that the soft memory target is not exceeded. Alternatively, or in addition, the method can include adjusting the termination score of the application based on a change in memory usage of the application. Alternatively, or in addition, the method can also include updating the soft memory target for the application based on detected change in a state of execution of the application. Alternatively, or in addition, the method can also further include statically predetermining the soft memory targets based on historical data on the amount of memory actually used by a representative range of applications in a given state or of a particular type, a device type, a device memory configuration, or any combination thereof.

### Example 5

This example provides for an example computer-readable storage device for managing memory usage using soft memory targets. The example computer-readable storage device includes executable instructions that can be executed by a processor to cause the processor to publish soft memory targets for a plurality of applications. The executable instructions can be executed by the processor to statically predetermine the soft memory targets based at least on a detected state of execution of each application and a size of the memory. The executable instructions can be executed by the processor to detect that an application exceeds the soft memory target. The executable instructions can be executed by the processor to detect that a total memory usage of the system exceeds a threshold amount. The executable instructions can be executed by the processor to terminate the application based at least in part on the detected soft memory target being exceeded and in response to detecting that the total memory usage of the system exceeds the threshold amount. The executable instructions can be executed by the processor to terminate the application based on a termination score. Alternatively, or in addition, the soft memory targets can be statically predetermined based on historical data on the amount of memory actually used by a representative range of applications in a given state or of a particular type. Alternatively, or in addition, the soft memory targets can be statically predetermined based on a device type. Alternatively, or in addition, the soft memory targets can be statically predetermined based on a device memory configuration. Alternatively, or in addition, the executable instructions can be executed by the processor to send the application a notification indicating the soft memory target is exceeded in response to detecting that the application exceeds the soft memory target.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for managing memory usage, the system comprising:
memory; and
a processor configured to:
publish soft memory targets for a plurality of applications, wherein the soft memory targets are to be statically predetermined based at least on a detected state of execution of each application and a size of the memory of the system;
detect that an application exceeds the soft memory target;
detect that a total memory usage of the system exceeds a threshold amount; and
terminate the application based at least in part on the detected soft memory target being exceeded and in response to detecting that the total memory usage of the system exceeds the threshold amount.

2. The system of claim 1, wherein the processor is to send the application a notification indicating the soft memory target is exceeded in response to detecting that the application exceeds the soft memory target.

3. The system of claim 1, wherein the processor is to terminate the application based on a termination score, wherein the termination score is based on execution state, application memory usage, and the detected soft memory target being exceeded.

4. The system of claim 1, wherein the processor is to allow the application to continue running with the soft memory target exceeded in response to detecting that the total memory usage of the system does not exceed the threshold amount.

5. The system of claim 1, wherein the application is to reduce application memory usage in response to receiving a notification indicating that the soft memory target is exceeded.

6. A method for managing memory usage, comprising:
publishing soft memory targets for a plurality of applications, wherein the soft memory targets are to be statically predetermined based at least on states of execution of the plurality of applications and a total available system memory;
generating a termination priority list for the plurality of applications based on a termination score for each application, wherein the termination score for each application is calculated based at least on the detected state of execution of each application and whether the soft memory target for each application is exceeded; and
terminating an application with the termination score that exceeds the termination score of other applications in the termination priority list in response to detecting that a memory usage of the total available system memory exceeds a threshold amount.

7. The method of claim 6, further comprising sending a notification to the application in response to detecting that the soft target for the application is exceeded.

8. The method of claim 6, further comprising updating the soft memory target for the application based on a detected change in a state of execution of the application.

9. The method of claim 6, further comprising adjusting the termination score of the application based on a change in memory usage of the application.

10. The method of claim 6, further comprising providing the application with a callback to be used to determine an amount of memory to release based on the soft memory target.

11. A system for managing memory usage, the system comprising:
memory; and
a processor configured to:
statically predetermine soft memory targets based on execution states and a total memory size of the system;
publish the soft memory targets to the applications;
assign the applications termination scores based on execution state;
detect an application exceeds a soft memory target;
increase the termination score of the application in response to detecting the application exceeds of the soft memory target;
detect that a total memory usage of the system exceeds a threshold amount; and
terminate an application with a higher termination score than other applications.

12. The system of claim 11, wherein the processor is to send the application a notification indicating that the soft memory target is exceeded.

13. The system of claim 11, wherein the soft memory targets are to be statically predetermined based on historical data on the amount of memory actually used by a representative range of applications in a given state or of a particular type.

14. The system of claim 11, wherein the soft memory targets are to be statically predetermined based on a device type.

15. The system of claim 11, wherein the soft memory targets are to be statically predetermined based on a device memory configuration.

16. A method for managing memory usage, comprising:
statically predetermining soft memory targets based on execution states and a total memory size of a system;
publishing the soft memory targets to the applications;
assigning the applications termination scores based on execution state;
detecting an application exceeds a soft memory target;
increasing the termination score of the application in response to detecting the exceeding of the soft memory target;
detecting that a total memory usage of a device exceeds a threshold amount; and
terminating an application with a higher termination score than other applications.

17. The method of claim 16, further comprising detecting that the application does not exceed the soft memory target and decreasing the termination score of the application in response to detecting that the soft memory target is not exceeded.

18. The method of claim 16, further comprising adjusting the termination score of the application based on a change in memory usage of the application.

19. The method of claim 16, further comprising updating the soft memory target for the application based on detected change in a state of execution of the application.

20. The method of claim 16, further comprising statically predetermining the soft memory targets based on historical data on the amount of memory actually used by a representative range of applications in a given state or of a particular type, a device type, a device memory configuration, or any combination thereof.
